(19) United States
(12) Patent Application Publication
(10) Pub. No.: US 2021/0056621 A1
(43) Pub. Date: Feb. 25, 2021

(54) METHODS AND SYSTEMS FOR IMPROVING CASH FLOW

(71) Applicant: Project Surety Consultants, LLC d/b/a Raffuel Surety Group, Princeton, NJ (US)

(72) Inventors: Amit Baria, Jersey City, NJ (US); Steven Raffuel, Princeton, NJ (US)

(21) Appl. No.: 16/688,012

(22) Filed: Nov. 19, 2019

Related U.S. Application Data
(60) Provisional application No. 62/889,139, filed on Aug. 20, 2019.

(51) Int. Cl. G06Q 40/02; G06Q 20/40; H04L 9/06; G06Q 30/06; G06Q 40/08

(52) U.S. Cl. CPC G06Q 40/025; G06Q 20/405; G06Q 40/08; G06Q 30/0645; H04L 9/0637

(57) ABSTRACT

The present disclosure pertains to a system configured to improve cash flow in an agreement. Some embodiments may receive, from a party of the agreement, a request to liquidate guaranteed capital owed to a payee in advance of a predetermined structure; determine whether to initiate a surety bond responsive to the request; prepare the surety bond for the guaranteed capital; send the surety bond to a custody, obligee, or escrow agent; and automatically detect whether the payer fulfilled a condition of the agreement.

### CROSS-REFERENCE TO RELATED APPLICATIONS

This application claims the benefit of the priority date of U.S. provisional application 62/889,139 filed on Aug. 20, 2019, entitled “Methods and Systems for Improving Cash Flow,” the content of which is incorporated by reference herein in its entirety.

### TECHNICAL FIELD

This application is generally related to methods and systems for improving cash flow. In particular, the methods and systems described herein for improving cash flow can at least be employed in the context of service-related agreements and/or commercial transactions.

### BACKGROUND

Surety bonds are performance guarantees issued by an insurance company on behalf of a principal whereby the surety/insurer legally binds itself to the performance of a contractual obligation of the principal. The beneficiary of the surety bond is called an obligee. The obligation guaranteed may include payment to the obligee for an amount of money. As such, the obligee receives the benefit of the surety bond, the surety assures the obligee that should the principal fail to perform the task, the surety will do so.

Generally, surety bonds are unsecured, third-party credit extensions operating as a performance guarantee. Stated differently, surety bonds act as a financial instrument that guarantees the performance obligation of a first party under its contract with a second party. By so doing, the second party is protected against financial risk should the first party default on its contractual obligation. In one example, tenants (second party) are known to post security deposits to a landlord (first party), who then forwards them into escrow (third party) for a duration of a lease agreement. The one example exemplifies a problem of restricting monies via escrow or by freezing cash associated with a commercial transaction or service-related agreement.

Underwriting surety bonds requires extensive consideration in arriving at a fair price for the bonds. Some factors include but are not limited to the credit quality of the applicant and the risk profile of the underlying performance obligation. Evaluating these factors often requires significant due diligence, which results in delays of completing the underwriting process. What is desired in the art is a technique and system of streamlining and accelerating the underwriting, pricing, and policy issuance process for surety bonds particularly with regard to speed of completion and precision in view of the performance obligation.

### SUMMARY

Systems and methods are disclosed for improving cash flow (e.g., by freeing up escrowed or frozen cash) in a commercial transaction or services-related agreement. Accordingly, one or more aspects of the present disclosure relate to: receiving, from either a payer or payee of the agreement, a request to preserve or liquidate guaranteed capital owed to the payee, in advance of a predetermined structure; determining whether to initiate a surety bond responsive to the request; preparing the surety bond for the guaranteed capital; and sending the surety bond to a suitable facilitator (“custody”), obligee, or escrow agent.

Another embodiment of the disclosure is directed to a financial product or vehicle of a blockchain (e.g., a smart contract) that is configured to self-execute upon recognizing specific conditions being met.

These methods may be implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system in which cash flow is improved, in accordance with one or more embodiments.

FIG. 2A illustrates an exemplary guaranteed compensation cash flow architecture, in accordance with the prior art.

FIG. 2B illustrates an exemplary guaranteed compensation bonded cash flow architecture, in accordance with one or more embodiments.

FIG. 3A illustrates an exemplary security deposition transaction flow architecture, in accordance with the prior art.

FIG. 3B illustrates an exemplary security deposition flow with a deposit release bonds architecture, in accordance with one or more embodiments.

FIG. 4 illustrates a process for improving cash flow, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

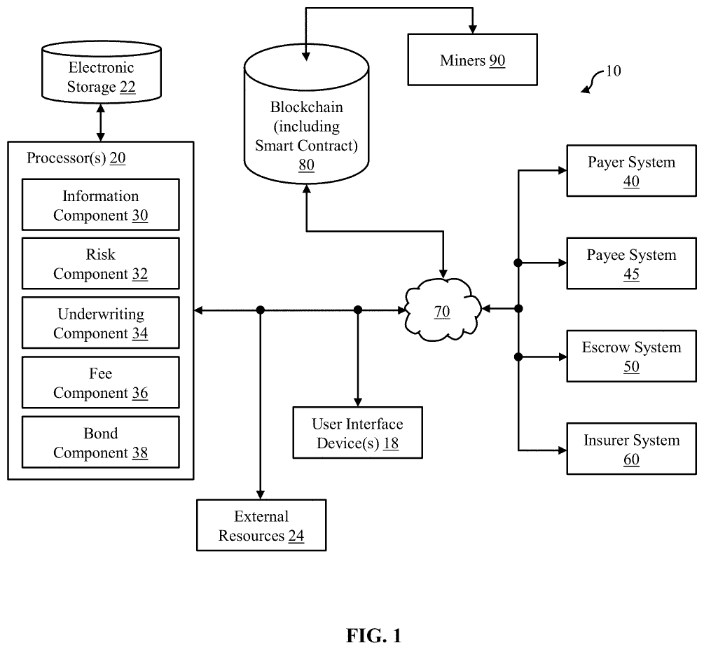

Presently disclosed are ways of improving cash flow of certain transactions, rather than funds being underused. FIG. 1 illustrates system 10 configured to improve real-estate transactions, the financial structuring of construction projects, sports contracts, international commerce (e.g., requiring advanced payment), and any transaction involving an escrow deposit, custodied funds, or a letter of credit. FIG. 1 depicts system 10 that further ensures proper performance of terms of an agreement that are pre-negotiated and executed between payer system 40 and payee system 45, while improving cash flow by freeing monies frozen in escrow.

In some embodiments, the agreement relates to a commercial or real-estate transaction involving an escrow deposit, custodied funds, or a letter of credit. In other embodiments, the agreement is a service-related performance contract. In either scenario, the agreement may specify the underlying obligation between parties 40 and 45. Based on the agreement, some embodiments of system 10 may thus guarantee payment of capital from payer system 40 to payee system 45. This capital may be any form of monies, equity, funds, or cash.

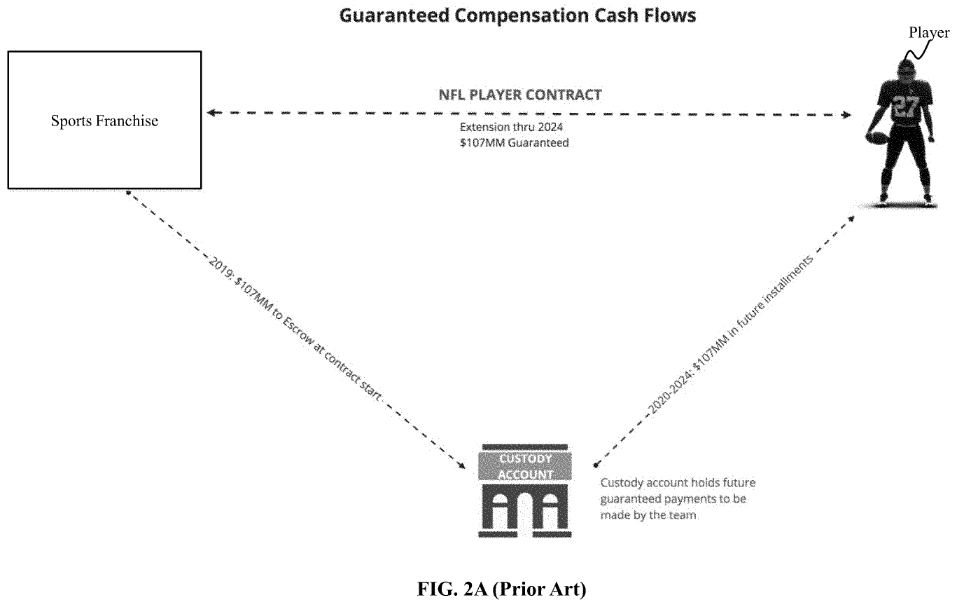

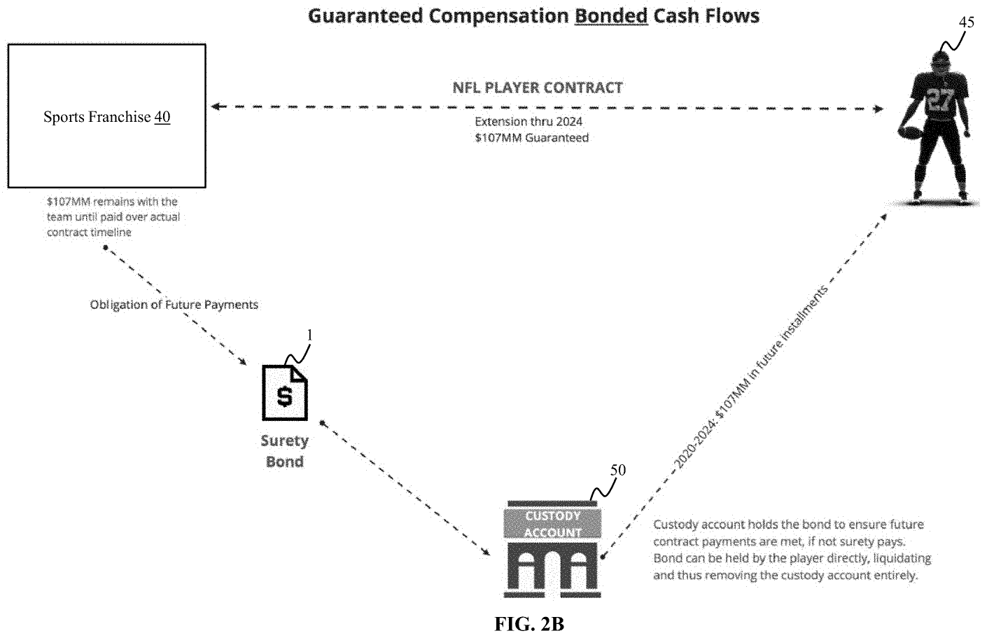

Competition among a sports league's teams to build skilled rosters has led to increased complexity via guaranteed money contracts. Some such contracts protect the franchise, while others favor the player. However, the loss of control via escrowed funds (e.g., amounting to many millions of dollars) is a major drawback. Simply put, setting aside millions of dollars now to fund future compensation drains cash flow. One example of this problematic scenario is depicted in FIG. 2A, i.e., where a player negotiates a multi-year contract valued at $107,000,000 USD resulting in those funds being held (e.g., in a custody of funds, escrow deposit, or a letter of credit) until the terms are fulfilled.

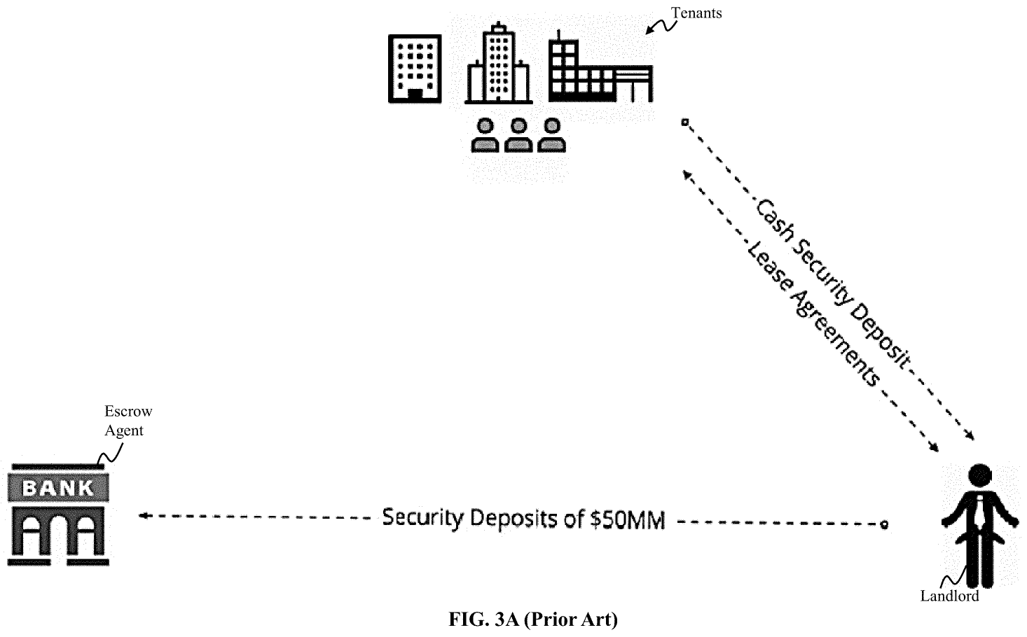

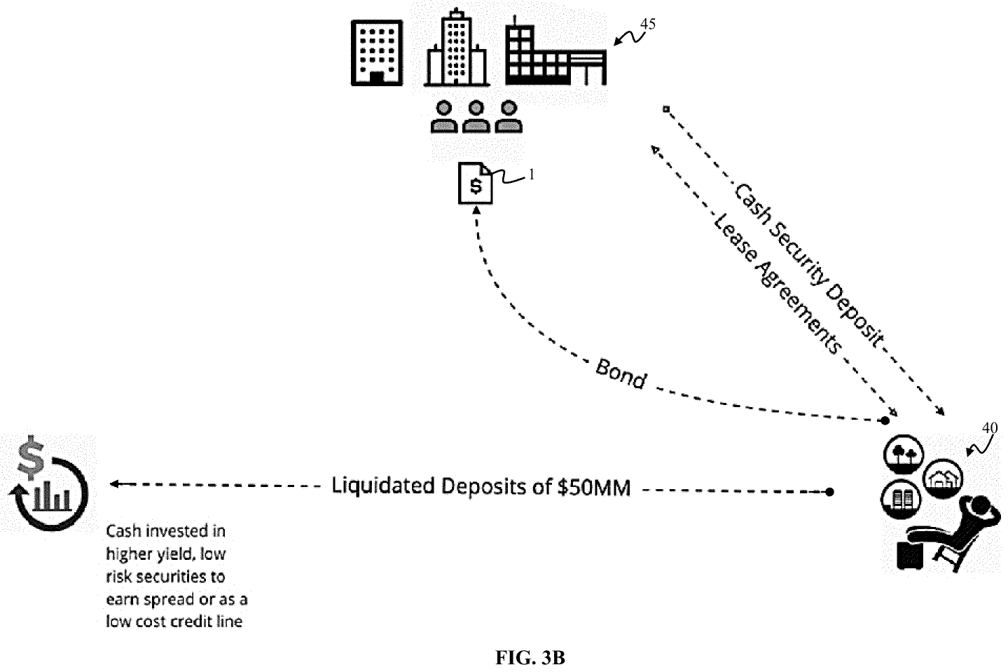

In another field of contemplated use, owners of residential, commercial, and industrial rental properties nationwide are known to hold security deposits from tenants. While statutes vary by state, generally deposits must be placed in escrow, e.g., in the form of interest-bearing savings accounts. In the state of New York, landlords of commercial residential apartment buildings hold tenant deposit monies in custody accounts bound by the terms and conditions outlined in lease agreements. This dollar amount, e.g., typically 1-2 months of rent, is intended to cover damages to the premises beyond normal wear and tear as well as alleviate the financial burden if a tenant breaks a lease prior to expiration without paying the remaining balance. Security deposit money is held throughout the duration of the lease and returned back to the tenant, plus nominal interest less damages, upon lease expiration. The custody of the security deposit in a separate bank account may be under control of the landlord. As depicted in the known scenario of FIG. 3A, an aggregate security deposit holding, from a plurality of tenants, is $50,000,000. Based on underlying lease obligations, statutes, and regulations, the landlord can maintain these deposits in a corporate savings account, e.g., yielding 30 basis points annually. Deposits plus accrued interest are returned to tenants upon lease expiration.

Some embodiments of system 10 may support a way to release tenant deposits via replacement use of surety bond 1 (e.g., a tenant deposit release bond). That is, bond 1 may be structured as a blanket surety bond that replaces long-term tenant security deposits. Similarly, some embodiments of system 10 may support a way to release owed salary payments via replacement use of surety bond 1. These blanket surety bonds may each liquidate deposits for (e.g., early) use during the term of the bond. Newly liquid cash subsequently can be allocated toward investment, new property acquisition, high interest debt reduction, overall growth, other near-term profitable use, or other activity.

In real-estate implementations, each tenant may continue to enjoy the protection afforded by applicable statutes and may be further enhanced via protection provided by a surety bond made payable directly to them from insurer system 60 (e.g., a highly rated insurance carrier), as depicted in FIG. 1. Surety bond 1 may substitute for the escrowed cash, with the obligation of landlord 40 remaining unaffected and compliant with applicable statutes and regulations. Indeed, the obligation is enhanced and secured by assets of the insurance company.

In some embodiments, surety bond 1 may be a debt security or another form of loan between payer 40 and payee 45 based on a schedule of an underlying agreement. Surety bond 1 may incorporate this agreement by reference. For example, the bond may be based on a lease agreement. In another example, the bond may be based on a service-related, performance agreement. In some implementations, obligations (e.g., of the tenant and landlord), statutes, and/or regulations of the underlying agreement may stipulate conditions triggering default and ways of enforcing performance of the agreed-to terms. To implement, the principal may alter its agreement to include language designating surety bond 1 as the default form of security (i.e., effectively substituting for monies deposited in escrow or at another custody).

Electronic storage 22 of FIG. 1 comprises electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., user interface device 18, processor 20, etc.). In some embodiments, electronic storage 22 may be located in a server together with processor 20, in a server that is part of external resources 24, in user interface (UI) devices 18, and/or in other locations. Electronic storage 22 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via UI devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply, a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 24 may be provided by other components or resources included in system 10. Processor 20, external resources 24, UI device 18, electronic storage 22, network 70, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN)), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

User interface (UI) device(s) 18 of system 10 may be configured to provide an interface between one or more users and system 10. UI devices 18 are configured to provide information to and/or receive information from the one or more users. UI devices 18 include a UI and/or other components. The UI may be and/or include a graphical user interface (GUI) configured to present views and/or fields configured to receive entry and/or selection with respect to particular functionality of system 10, and/or provide and/or receive other information. In some embodiments, the UI of UI devices 18 may include a plurality of separate interfaces associated with processors 20 and/or other components of system 10. Examples of interface devices suitable for inclusion in UI device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 18 include a removable storage interface. In this example, information may be loaded into UI devices 18 from removable storage (e.g., a smart card, a flash drive, a removable disk) that enables users to customize the implementation of UI devices 18.

In some embodiments, user interface (UI) devices 18 are configured to provide a UI, processing capabilities, databases, and/or electronic storage to system 10. As such, UI devices 18 may include processors 20, electronic storage 22, external resources 24, and/or other components of system 10. In some embodiments, UI devices 18 are connected to a network (e.g., the Internet). In some embodiments, UI devices 18 do not include processor 20, electronic storage 22, external resources 24, and/or other components of system 10, but instead communicate with these components via dedicated lines, a bus, a switch, network, or other communication means. The communication may be wireless or wired. In some embodiments, UI devices 18 are laptops, desktop computers, smartphones, tablet computers, and/or other UI devices.

Data and content may be exchanged between the various components of system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol Version 4 (IPv4) and Internet Protocol Version 6 (IPv6).

In some embodiments, each of processor 20, payer system 40, payee system 45, escrow system 50, and insurer system 60 may belong to a user device, a consumer electronics device, a mobile phone, a smartphone, a personal data assistant, a digital tablet/pad computer, a wearable device (e.g., watch), a personal computer, a laptop computer, a notebook computer, a work station, a server, a high performance computer (HPC), a vehicle computer, a game or entertainment system, a set-top-box or any other device. As such, each of processor 20, payer system 40, payee system 45, escrow system 50, and insurer system 60 is configured to provide information processing capabilities in system 10. Each of processor 20, payer system 40, payee system 45, escrow system 50, and insurer system 60 may comprise one or more of a digital processor, an analog processor, a digital circuit designed to process information, an analog circuit designed to process information, a state machine, and/or other mechanisms for electronically processing information. Although each of processor 20, payer system 40, payee system 45, escrow system 50, and insurer system 60 is shown in FIG. 1 as a single entity, this is for illustrative purposes only. In some embodiments, each of processor 20, payer system 40, payee system 45, escrow system 50, and insurer system 60 may comprise a plurality of processing units. These processing units may be physically located within the same device (e.g., a server), or they may represent processing functionality of a plurality of devices operating in coordination (e.g., one or more servers, UI devices 18, devices that are part of external resources 24, electronic storage 22, and/or other devices).

As shown in FIG. 1, processor 20 is configured via machine-readable instructions to execute one or more computer program components. The computer program components may comprise one or more of information component 30, risk component 32, underwriting component 34, fee component 36, bond component 38, and/or other components. Processor 20 may be configured to execute components 30, 32, 34, 36, and/or 38 by: software; hardware; firmware; some combination of software, hardware, and/or firmware; and/or other mechanisms for configuring processing capabilities on processor 20.

It should be appreciated that although components 30, 32, 34, 36, and 38 are illustrated in FIG. 1 as being co-located within a single processing unit, in embodiments in which processor 20 comprises multiple processing units, one or more of components 30, 32, 34, 36, and/or 38 may be located remotely from the other components. For example, in some embodiments, each of processor components 30, 32, 34, 36, and 38 may comprise a separate and distinct set of processors. The description of the functionality provided by the different components 30, 32, 34, 36, and/or 38 described below is for illustrative purposes, and is not intended to be limiting, as any of components 30, 32, 34, 36, and/or 38 may provide more or less functionality than is described. For example, one or more of components 30, 32, 34, 36, and/or 38 may be eliminated, and some or all of its functionality may be provided by other components 30, 32, 34, 36, and/or 38. As another example, processor 20 may be configured to execute one or more additional components that may perform some or all of the functionality attributed below to one of components 30, 32, 34, 36, and/or 38.

In some embodiments, surety bond 1 guarantees performance of an underlying obligation or agreement. That is, surety bond 1 is based on the agreed-to terms. For example, an agent of a football player (acting as the obligee) may negotiate a 10-year agreement having a payment structure guaranteed via surety bond 1. In this example, the player may receive 10% of the total, contracted amount of money per year, the surety bond itself being updated each year (e.g., reducing the total obligation to a remaining 90% by amortizing along with the payment terms). For example, if the underlying agreement states that the obligation of a sports franchise owner (acting as the principal) is reduced annually to the extent of actual payments made, then the bond would automatically follow. That is, the bond would effect renewal premiums, e.g., charging from $100 million USD to $90 million USD, and then to $80 million USD the following year. The obligation of the surety may be reduced dollar for dollar with performance of the obligation by the insured (i.e., the principal). For example, the sum of the bond is reduced, and directly offset, by payments made under XYZ contract to a sports player for the next N number of years.

The surety (e.g., processor 20 of FIG. 1) may assure the obligee that the principal will perform the necessary payments. In some embodiments, a renewal invoice may be periodically (e.g., annually) sent out, which is not necessarily a new bond. That is, once the bond is executed the bond may be in place for the lifetime of the obligation. The obligation may specify an amount to charge for those renewal premiums based on a sum of the bond. And the obligation may specify a guaranteed payment amount to a party in the event of a default (by another party) in a future year.

In some implementations, if a sports player, who is a party to surety bond 1, becomes injured or passes away, then the underlying agreement or contract between the team owner and the player is what guides the obligation of the bond. For example, the contract may stipulate that in the event of death or disability a party will pay a certain amount of money to their heirs over that same period of time; the bond thus stays in force. But if the guaranteed money is not stipulated to survive death or disability, then the obligation of the owner and the bond become null and void, at that point in time. In another example, if the player defaulted on the contract for being suspended, the owner could take back the guaranteed money, the contractual obligation and/or bond being terminated at that point. Since the bond may be directly dependent on the underlying contract, if the contract is fulfilled, then the obligation of the bond may be fulfilled. For example, for a construction contract, once built, a building may be turned over via a certificate of occupancy, which is tantamount to completion of the contract and performance of the bond obligation.

The disclosed approach for improving cash flow may relate to any service-related agreement. For example, the service-related agreement may include any structured compensation package negotiated between two parties. This includes employer/employee agreements as well as consulting or contractor agreements. In an exemplary embodiment, the service-related agreement involves sports contracts. For example, FIG. 2B illustrates a structured compensation package between an employer, i.e., an NFL team (franchise), and an employee, i.e., a football player on the roster. The instant application thus describes a vehicle including a guaranteed surety bond that may bring capital back to an employer/payer while preserving guaranteed employee/payee money.

As depicted in the exemplary embodiment of FIG. 2B, money in escrow, or any custody of funds, is replaced with a guarantee in the form of a surety bond. Surety bond 1 does not substitute the team's obligation to make future payments as required by the individual contract. Instead, it backstops the payment terms set forth in the player's contract. The owner effectively stands behind those obligations to make the payments, and if the owner does not make the payments then a surety consortium, as a co-guarantor, will make payment of that obligation. As such, payment terms set forth in a player's contract are insured.

In some embodiments, an owner of surety bond 1 may be payer 40. In other embodiments, the owner of surety bond 1 may be payee 45. In still other embodiments, the bond ownership may be shared between at least these parties, the owner generally being considered the bondholder, obligee, and beneficiary. As such, either party 40 or 45 may request creation of surety bond 1 for improving cash flow with respect to that party by liquidating funds in advance of scheduled payments. Similarly, payer 40 and/or payee 45 may be obligated to perform according to terms of an agreement. This bidirectional relationship may include implementations, e.g., where a real-estate tenant or sports player is obligated to pay monies to a landlord (developer) or sports franchise, respectively. In implementations involving sports contracts, cash flow of team 40 may be improved or cash flow of player 45 may be improved. And in implementations involving real-estate contracts, cash flow of landlord 40 may be improved or cash flow of tenant 45 may be improved.

A bidirectional relationship in implementations involving real-estate may imply that, while the mechanics generally remain the same (e.g., tenants posting security deposit into an escrow account), one of two outcomes utilizing the bond are possible: (i) the landlord produces a bond to the tenant (or certificate of insurance to tenants in the case of a blanket bond) enabling the landlord to liquidate already escrowed deposits; or (ii) the tenant produces a bond to the landlord, enabling them to get their cash back if already deposited or the bond substitutes for a cash deposit if a new transaction. A bidirectional relationship in implementations involving sports franchises may imply that, while the mechanics generally remain the same (e.g., teams escrow guaranteed payment ahead of schedule payment date), one of outcomes utilizing the bond are possible: (i) the franchise produces a bond to the player(s) enabling the landlord to keep cash out of escrow and with the team on new contracts or liquidate escrow if the account is currently funded, wherein the bond guarantees the team's obligation of future payments; or (ii) the player produces a bond to the team, enabling the players to liquidate escrowed future payments ahead of payment schedule.

In some embodiments, information component 30 may obtain a plurality of inputs that are used by risk component 32, underwriting component 34, and/or fee component 36 of processor 20. These inputs may include, e.g., financial information (e.g., financial statements, credit report, etc.), personal information (e.g., lifestyle choices, age, whether have children, neighborhood of residence, and/or other demographic values), medical information, juridical information, and/or other information suitable for determining a creditworthiness of payer system 40 and/or payee system 45. In some embodiments, risk component 32 may compare at least some of these inputs against predetermined (e.g., financial) criteria and automatically determine a risk metric based on the comparisons. For example, risk component 32 may determine a risk metric, for sports franchise 40, based on such attributes as revenue, assets, and/or cash flow over a period of time (e.g., 5-10 years). In this example, risk component 32 may determine the risk metric based on intangible aspects of the business, such as monetary value of TV rights (e.g., market share of TV revenue), merchandizing, franchise value, etc. In another example related to real-estate or construction, risk component 32 may determine risk based on a size of a building, activities planned to be performed in that building, its geographic location (e.g., which could be associated with a risk of being affected by a natural disaster, such as a hurricane or earthquake), type of building (e.g., multi-tenant residential or single tenant commercial), historical occupancy rates, loan to value (LTV) ratio, surrounding neighborhood (e.g., whether urban, suburban, or rural), a size of the share of the market, and/or other characteristics related to the lease agreement. Several of these parameters may be analyzed as part of a decision tree underlying a display provided by UI device 18.

In some embodiments, UI device 18 may be used by a contracted party to input their own data after submitted a request. That is, information component 30 may execute a decision tree (e.g., providing a list of questions) in response to the request. This tree may include paths for determining, from the party, an identifier (e.g., tax ID) and/or legal name for each party, an amount of funds, a date/time of scheduled payments, a property address (where applicable), a duration of the agreement, assets to guarantee, and/or another characteristic, each of these parameters being weighted. In blockchain implementations, the smart contract of blockchain 80 may leverage the user interface, which may facilitate administrator access.

In some embodiments, UI device 18 is used to support (e.g., financial) criteria for facilitating the determination as to whether to proceed to initiate surety bond 1. For example, the UI may display this criteria to payer system 40 and/or payee system 45 and then responsively receive corresponding input data (e.g., by providing answers or other particularities of the parties subject to the criteria). A level of acceptability of risk may be one such criterion.

In some embodiments, information component 30 may automatically obtain financial information from public filings, upon determining that a potential party to a surety bond is publicly traded. In some embodiments, information component 30 may directly obtain other financial information from a prospective party of surety bond 1. There may thus be, e.g., one path of the decision tree for publicly traded companies, and another path to take when the entity is private. Similarly, one path may be for handling letters of credit and another path based on cash escrow deposits. In some embodiments, information component 30 may obtain tax records based on a provided property address or tax ID.

In some embodiments, information component 30 may, upon or before execution of an underlying contractual agreement, continually crawl websites, online databases, and/or other public records in real-time. This crawling may include gathering and categorizing relevant, historical data, the relevance being determined based on a relation or closeness to a party of the contract (e.g., payer system 40, payee system 45, or another party of the contract). In these embodiments, information component 30 may similarly obtain historical data related to another party not involved in an underlying contract but that is in a same class or category as a party to the contract. As such, information component 30 may gather data that risk component 32 may then act upon in determining a risk metric. For example, if a rate of arrest of players in a certain sporting league were above a threshold, risk component 32 may then accordingly adjust a risk metric for a player of this same sporting league involved in a contract seeking the disclosed cash flow improvement. In another example, information component 30 may obtain parameters of one or more other surety bonds (e.g., involving another real-estate property, landlord, and tenants) such that subsequent analysis by risk component 32 causes an adjustment to a risk metric. In some embodiments, underwriting component 34 may adjust terms and/or conditions of surety bond 1 based on one or more outputs from risk component 32 after this latter component performs analysis of the crawled data that may involve other parties, contracts, or bonds. This adjustment may be performed after an initial pass evaluation but prior to sending the surety bond to a custody, obligee, or escrow agent.

In some embodiments, risk component 32 may determine a risk profile based on the underlying contractual agreement (e.g., aggressiveness of the terms) and/or on one or more of its parties (e.g., profitability of payer system 40). In some embodiments, a weighting factor may be associated with each of the predetermined criteria used for evaluating risk such that each criterion potentially has a different level of importance. Risk component 32 may thus generate a risk score or risk rating based on weighted risk criteria. In some embodiments, risk component 32 may perform iterative risk analysis, including, e.g., a first pass that generally ensures finances of the payer satisfy a criterion and a second pass that specifically ensures other factors (e.g., demographics such as marital status, liens, health of the party, etc.) satisfy one or more other criteria.

In some embodiments, underwriting component 34 may determine whether to initiate surety bond 1 or proceed with its issuance based on such risk metric(s) determined by risk component 32, e.g., if a determined amount of risk that needs to be taken is less than the acceptable level. This determination may be based on one or more attributes of a request (and any real-time evaluations, e.g., of online sources) that is sent from one of the parties of the bond. In some embodiments, underwriting component 34 may evaluate the credit quality of the applicant and the risk profile of the underlying performance obligation. For example, underwriting component 34 may evaluate one or more facts (e.g., related to economic viability, analysis of historical cash flows, and consideration of collateral assets). In some embodiments, underwriting component 34 may determine whether a cash flow of a party satisfies a criterion before making a final determination as to whether to proceed to initiate the bond.

In some embodiments, underwriting component 34 may perform at least preliminary underwriting and/or risk assessment activities (e.g., based on an agreed upon format). That is, need for third-party underwriters may be eliminated. And risk assessment of people (e.g., one or more natural or juridical people) and/or places (e.g., one or more buildings or structure) may be performed. For example, these underwriting and/or risk assessment activities may be based on validity of financial input(s). In this or another example, underwriting component 34 may perform these underwriting and/or risk assessment activities based on quality of the financial input(s).

In some embodiments, risk component 32 and underwriting component 34 may eliminate reliance on human subjectivity, which is often erroneous. That is, the disclosed approach expedites and accelerates the underwriting process based on known criteria, while at the same time improving precision and safety via better quality determinations (e.g., as to whether to initiate surety bond 1) by eliminating reliance on flawed, human subjectivity.

In some embodiments, underwriting component 34 may guarantee payment via insurer system 60, in case of damage or financial loss. In doing so, underwriting component 34 may accept the associated, financial risk. In these or other embodiments, a third-party underwriting agency may be involved to provide formal approval (e.g., of an output from underwriting component 34, when said output is below a threshold). For example, underwriting component 34 may provide this agency a weighted score determined by risk component 32. In some embodiments, a party may pay an insurance company directly, and then the insurance company may remit a determined fee percentage or portion back to an entity associated with processor 20.

In some embodiments, fee component 36 may compute a service fee for the surety bond based on a determination as to whether to initiate surety bond 1. For example, fee component 36 may determine a service fee based on a risk score and/or risk rating determined for the underlying agreement and/or for payer system 40 by risk component 32, and the fee may be based on a suitable cost category. And fee component 36 may use such metric(s) for determining a percentage or portion of the total cost for issuing the bond, i.e., for charging this fee. This fee may be distinct from a bond fee. Each of these determined metrics may form part of a risk profile and may be inversely proportional to a credit worthiness. In some embodiments, fee component 36 may not determine a fee and/or bond component 38 may not issue the bond based on the determined metric being too low.

In some embodiments, fee component 36 may determine the cost of procuring the surety bond and then divide the service fee among the contracted parties. For example, payer system 40 may be responsible for paying the service fee. In another example, payee system 45 may be so responsible. And, in yet another example, each of systems 40 and 45 may be responsible for a portion of this fee.

By the disclosed approach, payer system 40 may pay the designated amounts when actually due rather than in advance. As a result, payer system 40 may be free to utilize the capital now, or sometime in the near future, and still meet various different obligations. For example, these obligations may include payments to payee system 45, umbrella (e.g., league of the sports team) requirements, and conditions reflected in a collective bargaining agreement (CBA).

According to another embodiment, the guaranteed surety bond may be utilized by the player, i.e., payee system 45. For example, the player can liquidate guaranteed monies upfront via surety bond 1. As a result, the player may be advanced guaranteed monies prior to the actual payment schedule.

In some embodiments, surety bond 1 may be backed by one or more highly rated (e.g., A+) insurers, such as insurer system 60. In some embodiments, processor 20 may operate as a surety consortium and perform some underwriting services. As such, surety 20 effectively lowers the overall risk by cooperating with insurer system 60. In some embodiments, bond component 38 may identify an insurance company capable of accepting the determined risk of default (i.e., by at least one of the parties) of the agreement.

In some embodiments, the underwriting authority is insurance company 60. In other embodiments, the above-described approach may be executed to determine a level of authority or support that insurance company 60 is willing to provide to a requester or owner of surety bond 1. This level may be further predicated on internal limitations. For example, based on a score or rating from risk component 32, fee component 36 may automatically determine a price of surety bond 1 (e.g., one percent per annuum) and a percentage amount (e.g., 70%) to write up the aggregate risk. In some embodiments, a total price of bond 1 may be based on a fee for servicing a request to initiate (e.g., including particular risk analysis) and/or manage surety bond 1. And another fee may be charged for transferring ownership of bond 1.

By the disclosed approach, payer system 40 and/or payee system 45 may benefit. For example, in sports contract implementations, the franchise 40 may benefit by retaining control of guaranteed money otherwise secured in escrow or any custody of funds. And player 45 may benefit from receiving additional protection of their guaranteed money from highly rated insurers.

In some embodiments, trusted party 50 may be a custody of funds, such as a bank or escrow agent. That is, escrow system 50 may be a recipient of surety bond 1, effectively ensuring and/or assuring payment of a certain amount of capital, at a certain schedule or according to another condition. In some embodiments, trusted party 50 may not have to take possession of and/or prolongedly hold surety bond 1. For example, once trusted party 50 obtains notice of generation or transmission of surety bond 1, e.g., when cash is returned to landlord developer system 40. As such, tenant system 45 is the obligee, who is the beneficiary of the generation and/or recipient of the transmission. That is, tenant system 45 or escrow system 50 may hold surety bond 1. Similarly, but in different implementations, player system 45 or escrow system 50 may hold surety bond 1.

In some embodiments, insurer system 60 may be a bank, insurance company, or investment firm. In some embodiments, insurer system 60 may operate as the surety for bond 1. And solvency of this insurance company may be verified by private audit, governmental regulation, or both.

In some embodiments, the guaranteed capital may be partially guaranteed, i.e., via a set of bonuses, including those of a contractual agreement that are based on skill, salary-cap, and/or injury guarantees. For example, a contractual agreement may require payments to NFL player 45, e.g., when NFL player 45 performs a certain amount of training exercises (workouts and/or practices), performs a certain amount of season and/or post-season games, signs the contractual agreement, remains each year as a player in good standing, and/or undergoes another periodic, irregular, or on-demand activity.

In some embodiments, bond component 38 may prepare surety bond 1 for the guaranteed capital and then send the bond to escrow system 50. Bond component 38 may further determine whether a party to an agreement performed in conformance with its terms (e.g., based on real-time evaluation of one or more online sources). For example, bond component 38 may determine that this party electronically signed the agreement. In some embodiments, underwriting component 34 may (e.g., alone or in conjunction with insurer system 60 and/or an independent underwriting agency) control identified collateral as a way to secure at least a portion of surety bond 1.

In some embodiments, after receiving confirmation of a first installment payment, bond component 38 may automatically adjust one or more parameters of surety bond 1. This adjustment may be responsive to payment performance of payer system 40 (e.g., during a predetermined period of time). The one or more adjustable parameters may comprise a structure, which is revised after the confirmation is received. In some embodiments, bond component 38 may automatically reduce the bond amount with each installment payment. For example, an initial $107,000,000 USD bond amount (as depicted in FIG. 2B) may be reduced to $90,000,000 USD in year two.

In some embodiments, bond component 38 may monitor information about payer system 40 and/or payee system 45, and then it may flag improprieties. For example, when bond component 38 detects a breach of contract and/or when bond component 38 determines that there exists legal action (e.g., an arrest warrant) or prejudicial news (e.g., in a publication) against one of systems 40 and 45, the UI may alarm a user. In blockchain implementations (which is discussed in greater detail below), the smart contract may perform this monitoring and flagging.

In some embodiments, bond component 38 may obtain, after an alleged default in an attempt to seek a remedy, evidence of terms' acceptance or of a default from a bond beneficiary. The principal of indemnity may then become involved. For example, a sports team may provide their indemnity to a bonding company for surety bond 1, effectively conveying that they agree to defend the bonding company, hold the company harmless, and repay the company if they are asked to incur legal fees and make payment on the team's behalf. In that scenario, the default would first be rendered under the underlying agreement, and then the contract would be revisited for identifying remedies for the default (e.g., a player may have a right to demand acceleration of the balance of the payments, become a free agent, or another suitable remedy). As a result, the bonding company may step in to help secure the remedy or to indemnify.

In embodiments related to real-estate transactions, bond component 38 may transfer a master surety bond to a bank (or escrow system 50 or another trusted party or even surety consortium 20, which may be implemented in software) for an aggregate amount of deposits and then issue a certificate of insurance to each tenant (beneficiary) that provided one such deposit. That is, the bank may temporarily hold the deposits, until the bank is notified that these certificates have been issued. After the notification, the bank may trigger release of the deposited funds such that the bank ceases involvement. The liquidated deposit may thus move from the bank to developer 40. Then, surety 20 may provide bond 1 to developer 40 so that developer 40 can forward to tenant 45. As such, surety bond 1 may be provided to tenants 45 as a form of guarantee that they are going to get their money back at the end of the lease. This example shows how cash flow may be improved by the disclosed approach. That is, landlord 40 may now invest the money, e.g., in an interest bearing account or other higher yielding security.

FIG. 3B shows cash security deposits going from tenants 45 to landlord 40, and it shows surety bond 1 going in the reverse direction. FIG. 3B thus exemplarily shows an aggregate security deposit holdings in an amount of $50,000,000 USD. In some embodiments, surety consortium (e.g., processor 20) may prepare a bond for (e.g., short term) custody at a banking institution or escrow 50, for the aggregate amount of $50,150,000 USD, which is due back to the tenant (i.e., beneficiary). The additional $150,000 USD may exemplarily cover the full deposit amount and accumulated interest rate generated from savings of 30 basis points. Here, the landlord's total cost equates to 30 basis points in interest plus bond premium up to 1.0%, for a total of 1.3%. By simply redirecting the received funds into a higher yield CD at 3% yields a 170-basis point profit, without modifying the deposit custody process.

Reduced friction can be achieved through efficient integration of the broker and surety into an existing leasing process and property management system via a bond form and leasing agreement. In some embodiments, a master bond with an agreed maximum limit of liability is placed, with individual sub-limits provided to each tenant in accordance with their specific escrow value. In other embodiments, master bonds for all tenants of a building may not be used, i.e., in favor of using individualized bonds for each tenant. In either case, the bonds will be evidenced by certificates of insurance issued to tenants, along with a copy of the bond.

In implementations involving blockchain 80, at least some of the operations disclosed herein to be performed by information component 30, risk component 32, underwriting component 34, fee component 36, and/or bond component 38 may be performed automatically by the smart contract. For example, the smart contract may calculate a corresponding amount of risk to absorb (e.g., a hundred cents on the dollar, fifty cents on the dollar, etc.) based on the risk score or rating determined by risk component 32. In other embodiments, the smart contract may itself determine risk, via blockchain 80, instead of relying on activity of risk component 32.

A blockchain may be described as a distributed network and a decentralized (e.g., peer-to-peer) system. Decentralizing file storage on the Internet leads at least to the benefit of not having a single point of failure. By storing blocks of information that are identical across its network, blockchain 80 cannot be controlled by any single entity. From a simplistic viewpoint, distributing data throughout the network protects it from getting hacked or lost. The blockchain technology thus inherently guarantees the validity of a transaction by recording it not on a main register or ledger but on a connected, distributed system of registers or ledgers. The state of the ledger may be determined by consensus among independently operated nodes (e.g., systems, servers, computers, databases, or the like, which may be operably connected to one another), which form blockchain 80. For example, the data of blockchain 80 stored at its nodes may demonstrably reflect previous transactions, and such demonstration may be performed cryptographically (e.g., via a decryption function or use of a hash).

Blockchain 80 may thus be a set of protocols and cryptographic methods that enable a network of computing devices to work together to securely record data with a shared, open database. This database may comprise a series of (e.g., encrypted) blocks that contain the data. Blockchain 80 may comprise a distributed ledger that is updated based on transactions. Distributed blockchain ledger 80 may record basic attributes of each transaction (e.g., an identifier for each of one or more parties, a currency amount of the transaction, a type of transaction, a date/time of transaction, and/or another transaction characteristic). Since blockchain 80 may, in some implementations, be an open ledger, anyone inspecting these records would have reasonable assurance that the data points have not been tampered. As long as there are enough independent, protocol-abiding nodes in the network, the ledger is tamper-proof.

A partial or full copy of the blockchain may be downloaded automatically upon joining the blockchain network. Once reconciled, the data embedded within the network is public (i.e., the tamper-resistant ledger is accessible by any user of the network). The blockchain data may be added irreversibly, i.e., corrupting any unit of information would require use of an infeasible amount of computing power (e.g., to override at least 50% of the networked nodes). Each of systems 40, 45, 50, and 60 may perform a transaction that provides input data to a smart contract of blockchain 80. Blockchain 80 may enable the coding of the smart contract.

In some embodiments, the smart contract is a decentralized application that is integrated into or stored on blockchain 80. The smart contract may be configured to self-execute to facilitate, monitor, or enforce transactions (e.g., analyzed based on the logical terms of the smart contract) between parties of surety bond 1. For example, the smart contract may validate whether activity or an event of a transaction record performed by payer system 40 and/or payee system 45 meets one or more predetermined conditions of the underlying agreement. As such, the smart contract may include logic and/or rules that securely and transparently emulate contractual clauses. The self-executing nature of the smart contract may reduce the need of human interaction, including avoidance of associated mistakes and latencies.

In addition to keeping records of transactions, blockchain 80 may also be capable of keeping records of changes to a state of the smart contract hosted on the blockchain. In some embodiments, the smart contract may automatically execute the agreement based on electronic signatures from one or more parties and on a determination of risk component 32. In some embodiments, the smart contract may obtain and review contract terms. Then, the smart contract may monitor activity of blockchain 80 and determine that a first party (e.g., payer 40 or payee 45) performed in conformance with the terms of the agreement based on at least a portion of the schedule for payments from the first party to a second party being fulfilled. For example, automatic execution of the smart contract logic may include determining that a predetermined threshold number of nodes have agreed that the smart contract has been satisfied. As a result, and upon determination of conformance, blockchain 80 may facilitate distribution of the agreed-to payment amount, and payer system 40 may be relieved of an obligation.

In some embodiments, the smart contract may govern identified collateral property as a way to secure at least a portion of surety bond 1.

In some embodiments, blockchain 80 may include a plurality of blocks of transactions. Each block of the chain may include one or more of terms of a contract, records related to the terms' performance, payments made, records related to defaulting activity, and details of surety bonds (e.g., a schedule for payments to the payees). In some embodiments, these transactions may be encrypted using informationally-theoretically secure encryption on the blockchain. These transactions may be collected via blockchain 80 from a plurality of connected nodes or devices. Each block of a blockchain may, in some embodiments, contain a hash of the previous block (or a hash of that hash), thereby forming a chain. Just as transactions are added to a block in chronological order (e.g., in an order that they were broadcast from one node to other nodes), blocks in the blockchain are thus permanently added to the chain in chronological order.

In some embodiments, bond component 38 may be configured to interface with blockchain 80 for adding information pertinent to the smart contract. For example, bond component 38 may generate a properly formatted transaction record for adding this transaction to blockchain 80. Miners 90 may then gather this transaction record along with other transaction records generated in a same time frame for generating a next block to add to blockchain 80. For example, miners 90 may validate the transactions (e.g., redoing at least some of the computations that resulted in the transactions) such that the blockchain results in a self-auditing ecosystem. Miners may then add the validated transactions to a block they are building and then may broadcast a completed block to other nodes so that all have a copy of the blockchain. The blockchain network thus reconciles every broadcast transaction in intervals. In some embodiments, a client device, miner, or other node that generated the block may be rewarded a unit value (e.g., token) and any change resulting from the transaction.

In some embodiments, the smart contract may be triggered to execute a provision (e.g., a remedy in the event of default) of a contract based on certain events that are determined to occur (or not occur as scheduled). The smart contract may then initiate disbursement or communication of the corresponding monies to payee system 45 from payer system 40 (or from insurer system 60 in event of default). The outputs of the transaction may also be recorded on blockchain 80, which enhances accountability of the operation of the smart contract.

In some embodiments, bond component 38 may facilitate sales of bond-like token coins that will allow payee system 45 to thereafter immediately collect (i.e., up-front) a large portion of monies guaranteed to said payee, which is considerably sooner, e.g., than upon fulfillment of a multi-year contract. These token coins may be based on blockchain 80. Payee 45 may then make monthly payments to token owners according to a schedule, with each payment fulfilling a condition of an underlying agreement. In some implementations, escrow system 50 may perform custody and escrow services related to these payments.

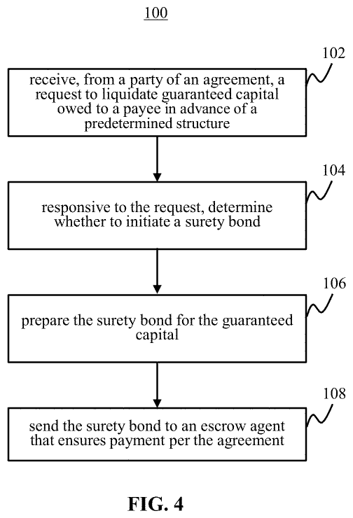

FIG. 4 illustrates method 100 for improving cash flow in relation to escrowed surety bonds, in accordance with one or more embodiments. Method 100 may be performed with a computer system comprising one or more computer processors and/or other components. The processors are configured by machine readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 4 and described below is not intended to be limiting. In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

At operation 102 of method 100, a request to liquidate guaranteed capital owed to a payee may be received from a party of an agreement, in advance of a predetermined structure associated with the agreement. As an example, either payer system 40 or payee system 45 may transmit this request to processor 20. In some embodiments, operation 102 is performed by a processor component the same as or similar to information component 30 (shown in FIG. 1 and described herein).

At operation 104 of method 100, a determination as to whether to initiate a surety bond may be performed responsive to the request. As an example, processor 20 or a smart contract of blockchain 80 may make this determination based on risk of the agreement and/or responsible party. In some embodiments, operation 104 is performed by a processor component the same as or similar to risk component 32 and underwriting component 34 (shown in FIG. 1 and described herein).

At operation 106 of method 100, the surety bond for the guaranteed capital may be prepared. As an example, surety bond 1 may be prepared for assuring payment and performance of terms of the agreement, i.e., between payer 40 and payee 45. The price of this bond may include a service fee. In some embodiments, operation 106 is performed by a processor component the same as or similar to fee component 36 and bond component 38 (shown in FIG. 1 and described herein).

At operation 108 of method 100, the surety bond may be sent to an escrow agent that ensures proper payment(s). As an example, escrow system 50 may obtain surety bond 1 and cooperate with insurer system 60 for guaranteeing payments, e.g., when no party is in default of the agreement. Escrow system 50 may ensure payment by payer 40 or by payer 45. In some embodiments, operation 108 is performed by a processor component the same as or similar to bond component 38 (shown in FIG. 1 and described herein).

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Several embodiments of the invention are specifically illustrated and/or described herein. However, it will be appreciated that modifications and variations are contemplated and within the purview of the appended claims.

1. A computer-implemented method for improving cash flow in an agreement relating to a sport or to real-estate, the method comprising:
receiving, from a payer of the agreement, a request to preserve guaranteed capital owed to a payee;
determining, responsive to the request, whether to initiate a surety bond based on (i) one or more attributes of the request and (ii) real-time evaluation of a plurality of different online sources;
preparing, responsive to the determination, the surety bond for the guaranteed capital;
sending the surety bond to a custody, obligee, or escrow agent; and
automatically detecting whether the payer fulfilled a condition of the agreement,
wherein the payer is a sports franchise or a landlord, and
wherein the payee is a sports player or a tenant.

2. The method of claim 1, wherein the determination includes evaluating a risk metric determined for at least one of the agreement and the payer.

3. The method of claim 1, further comprising:
computing, based on the determination, a service fee for the surety bond; and
adjusting, before the sending, one or more terms of the surety bond based on the real-time evaluation.

4. The method of claim 1, further comprising:
automatically adjusting, after receiving confirmation of a first installment payment, one or more parameters of the surety bond.

5. The method of claim 1, wherein payment of the capital to the payee is guaranteed over a predetermined period of time.

6. The method of claim 1, wherein the custody, obligee, or escrow agent is a recipient of the surety bond and ensures payment by the payer,
wherein the payer is a sports franchise or a landlord, and
wherein the payee is a sports player or a tenant.

7. The method of claim 5, wherein the automatic detection is performed via a smart contract,
wherein the smart contract includes rules that secure one or more contractual clauses encompassing the condition, the condition including a payment obligation to the payee within the predetermined period, and
wherein the contractual clauses are transparently emulated.

8. The method of claim 1, further comprising:
validating a transaction record based on the determination; and
adding the validated record to a blockchain.

9. The method of claim 1, further comprising:
providing a user interface (UI) configured to display a limited set of criteria for facilitating the determination to the payer.

10. A system, comprising:
a non-transitory memory including instructions for improving cash flow; and
a processor operably coupled to the memory for executing the instructions of:
receiving terms of an agreement relating to a sport or to real-estate between a first party and a second party, the terms including when to disseminate guaranteed capital from the first party to the second party;
identifying whether the agreement is associated with a surety bond for assuring the dissemination, including when a party defaults;
determining that the second party performed in conformance with the terms of the agreement based on real-time evaluation of one or more online sources; and
automatically executing the agreement based on the determination,
wherein the first party is a sports franchise or a landlord, and
wherein the second party is a sports player or a tenant.

11. The system of claim 10, wherein the agreement comprises a smart contract, and
wherein the smart contract is located on a blockchain, the processor being operatively connected to the blockchain.

12. The system of claim 10, wherein the processor further executes the instructions of:
identifying an insurance company capable of accepting a risk of default of the agreement by at least one of the parties.

13. The system of claim 11, wherein the blockchain comprises a transaction record associated with the surety bond, the transaction record including a schedule for payments to the second party, and
wherein the smart contract determines that the first party performed in conformance with the terms of the agreement based on the schedule.

14. The system of claim 11, wherein the processor further executes the instructions of:
receiving, from the first party, a request to issue the surety bond,
wherein the guaranteed capital is a security deposit received from the second party,
wherein the first party is a landlord, and
wherein the second party is a tenant.

15. The system of claim 14, wherein the processor further executes the instructions of:
receiving monies from the tenant according to a lease agreement.

16. The system of claim 15, wherein the smart contract automatically implements the lease agreement.

17. A computer-implemented method for improving cash flow in an agreement relating to a sport or to real-estate, the method comprising:
receiving, from a payee of the agreement, a request to liquidate guaranteed capital owed to the payee in advance of a predetermined structure;
determining, responsive to the request, whether to initiate a surety bond based on (i) one or more attributes of the request and (ii) real-time evaluation of a plurality of different online sources;
sending the surety bond to a custody, obligee, or escrow agent that ensures payment by the payee; and
automatically detecting whether the payee fulfilled a condition of the agreement,
wherein a payer of the agreement is a sports franchise or a landlord, and
wherein the payee is a sports player or a tenant.

18. The method of claim 17, wherein the determination includes evaluating a risk metric determined for each of the agreement, the payer, and the payee.

19. The method of claim 17, further comprising:
computing, based on the determination, a service fee for the surety bond; and
adjusting, before the sending, one or more terms of the surety bond based on the real-time evaluation.

20. The method of claim 17, further comprising:
identifying an insurance company capable of accepting risk of default of the agreement by the payee.
